(19) United States
(12) Patent Application Publication
(10) Pub. No.: US 2024/0245259 A1
(43) Pub. Date: Jul. 25, 2024

(54) Multi-Piece Cookware Device

(71) Applicant: William Altizer, Yorktown, VA (US)

(72) Inventor: William Altizer, Yorktown, VA (US)

(21) Appl. No.: 18/318,820

(22) Filed: May 17, 2023

Related U.S. Application Data
(60) Provisional application No. 63/440,133, filed on Jan. 20, 2023.

(51) Int. Cl. A47J 36/02; A47J 36/04; A47J 36/06; A47J 45/06; F16B 43/00

(52) U.S. Cl. CPC A47J 36/02; A47J 36/04; A47J 36/06; A47J 45/06; F16B 43/001

(57) ABSTRACT

A multi-piece cookware device is disclosed. The device is comprised of a body, a first segment, a second segment, and a third segment, each is preferably made from a metal or ceramic material that can withstand the high temperatures involved in cooking. Each segment is comprised of a fastener which allows the segments to easily connect to one another. The device may also be disassembled for a thorough cleaning by hand or by being placed in a dishwasher.

### CROSS-REFERENCE TO RELATED APPLICATION

The present application claims priority to, and the benefit of, U.S. Provisional Application No. 63/440,133, which was filed on Jan. 20, 2023, and is incorporated herein by reference in its entirety.

### FIELD OF THE INVENTION

The present invention relates generally to the field of cookware. More specifically, the present invention relates to a multi-piece cookware device. The device is comprised of a body having at least a first segment and at least a second segment. Each segment is preferably comprised of a fastener which allows the segments to easily connect to one another and then be disassembled for a thorough cleaning by hand or by being placed in a dishwasher. Accordingly, the present disclosure makes specific reference thereto. Nonetheless, it is to be appreciated that aspects of the present invention are also equally applicable to other like applications, devices, and methods of manufacture.

### BACKGROUND

A dishwasher can be great for cleaning dishes and other cookware in a timely and efficient manner. However, some cookware, such as glasses, must be washed by hand rather than being placed in the dishwasher as the dishwasher may damage or not properly fit or clean all areas of the cookware. However, cleaning cookware by hand can be a time-consuming effort. In addition, after hand-cleaning, the cookware may still not be properly cleaned, allowing for mold or other forms of bacteria to develop.

Therefore, there exists a long-felt need in the art for a device that can be used to cook or store food and that can be easily cleaned. More specifically, there exists a long-felt need in the art for a multi-piece cookware device that can be easily reduced in size to fit inside of a standard kitchen dishwasher. Furthermore, there exists a long-felt need in the art for a multi-piece cookware device that can be disassembled for easy cleaning.

The subject matter disclosed and claimed herein, in one embodiment thereof, comprises a multi-piece cookware device. The device is comprised of a body with at least a first segment and a second segment. Each segment is preferably made from a metal or ceramic material that can withstand the high temperatures involved in cooking. The segments of the device can be easily connected and disconnected to allow the device to fit in a standard kitchen dishwasher and/or be cleaned by hand. When the device is assembled, the device is watertight to provide a sealed and stable piece of cookware.

In this manner, the multi-piece cookware device of the present invention accomplishes all the foregoing objectives and provides a device that can be used to cook or store food and can be easily cleaned. More specifically, the multi-piece cookware device can be taken apart into separate pieces that can easily fit and be cleaned in a standard kitchen dishwasher or by hand. Furthermore, the multi-piece cookware device is durable, such that it can withstand the high temperatures typically used in cooking and cleaning.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multi-piece cookware device comprised of a body made of at least one a first segment and a second segment. The device may be any piece of cookware that can be used for cooking or storing of food or drink and may be disassembled for storage or ease of cleaning.

The segments of the device may be assembled and secured to one another to allow the device to act as cookware and also be disassembled for ease of cleaning. The first segment is comprised of a fastener that may attach to a fastener of the second segment. The connection between the first and second segments is made watertight to prevent leakage by an O-ring attached to the bottom edge of the first segment. In addition, a third segment is comprised of a fastener that may attach to the other side of the fastener of the second segment. The connection between the third and second segments is made watertight to prevent leakage by an O-ring attached to the top edge of the third segment.

The present invention is also comprised of a method of using the device. First, a device is provided comprised of a body comprised of a first segment and a second segment. Then, the device may be assembled by attaching the fastener of the first segment to the fastener of the second segment. Then, the device may be disassembled by detaching the second segment from the first segment. Next, each segment of the device may be cleaned either by hand or by being placed in the dishwasher.

Accordingly, the multi-piece cookware device of the present invention is particularly advantageous as it provides a device that can be used to cook or store food and can be easily cleaned. More specifically, the multi-piece cookware device is durable and capable of withstanding the high temperatures typically associated with cooking and cleaning. Furthermore, the multi-piece cookware device can be disassembled into multiple separate pieces that can easily be cleaned and fit into a standard kitchen dishwasher. In this manner, the multi-piece cookware device overcomes the limitations of existing cookware known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exploded view of one potential embodiment of a multi-piece cookware device of the present invention in accordance with the disclosed architecture; and

FIG. 2 illustrates a flowchart of a method of using one potential embodiment of a multi-piece cookware device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a cookware device that can be used to cook or store food and can be easily cleaned. More specifically, there exists a long-felt need in the art for a multi-piece cookware device that can be easily reduced in size to fit inside of a standard kitchen dishwasher. Furthermore, there exists a long-felt need in the art for a multi-piece cookware device that can easily be washed by hand.

The present invention, in one exemplary embodiment, is comprised of a multi-piece cookware device. The device is primarily comprised of a body having at least a first segment and a second segment. The device is designed to act as cookware that may be used for the cooking or storing of food and may be disassembled for storage or ease of cleaning in a kitchen dishwasher or by hand.

The device is comprised of at least two segments that, when assembled, may be used as a pan, pot, or other similar cookware product capable of cooking, serving, or storing food. The first segment of the device is comprised of an at least one O-ring, a bottom edge, and an at least one fastener. The second segment is further comprised of an interior surface, at least one fastener, a top edge, and a bottom edge. In addition, the third segment of the device is further comprised of an at least one O-ring, a top edge, and an at least one fastener.

When the device is assembled, the bottom edge of the first segment sits flush with the top edge of the second segment and the bottom edge of the second segment sits flush with the top edge of the third segment. The fasteners of the first segment may attach to the fastener of the second segment. In the preferred embodiment of the device, the fasteners of the first and third segments are male threads that screw into the fastener of the second segment, female threads. In this embodiment, the interior surface of the second segment may be comprised of the fastener of the second segment, whereas the fasteners of the first and third segments may extend from the bottom edge and top edge of the first and third segments, respectively.

Attached to the bottom edge of the first segment and the top edge of the third segment are O-rings. The O-rings of the first and third segments may prevent the device from leaking by creating a seal when the fasteners between the segments are fully tightened. In addition, the device is also comprised of a lid, further comprised of at least one handle. The lid may be used when cooking to retain heat on the inside of the device or to prevent the contents from leaking over the top of the device. Further, the handle of the lid may be used to safely move the lid in the event that the device is hot.

The present invention is also comprised of a method of using the device. First, a device is provided comprised of a body having at least a first segment and a second segment. Then, the device may be assembled by attaching the fastener of the first segment to the fastener of the second segment. Then, the device may be disassembled by detaching the second segment from the first segment. Next, each segment of the device may be cleaned either by hand or by being placed in the dishwasher.

Accordingly, the multi-piece cookware device of the present invention is particularly advantageous as it provides a device that can be used to cook or store food and can be easily cleaned. More specifically, the multi-piece cookware device can be separated into three separate segments from which the device may be easily and thoroughly cleaned or placed in a dishwasher for cleaning. Furthermore, the multi-piece cookware device can withstand the high temperature heat stress typically involved in cooking and cleaning. In this manner, the multi-piece cookware device overcomes the limitations of existing cookware known in the art.

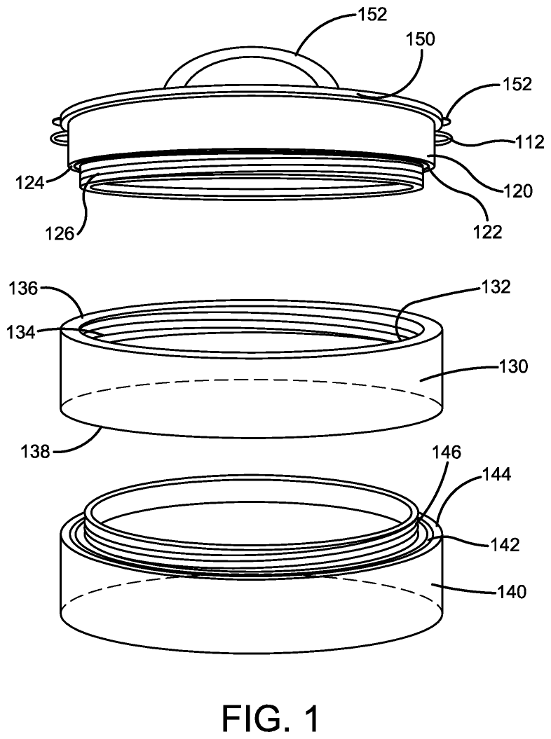

Referring initially to the drawings, FIG. 1 illustrates an exploded view of one potential embodiment of a multi-piece cookware device 100 of the present invention in accordance with the disclosed architecture. The device 100 is primarily comprised of a body 110 with at least a first segment 120 and a second segment 130, but also preferably a third segment 140. The device 100 is designed to act as cookware capable of being disassembled for ease of storage and to allow the device 100 to fit into a kitchen dishwasher and/or be cleaned by hand.

The body 110 of the device 100 may be made of any material typically used in cookware such as, but not limited to, stainless steel, aluminum, ceramics, cast iron, plastics, copper, glass, etc. The body 110 may be any cookware shape, but preferably resembles a variety of liquid holding vessels, including, but not limited to, drink pitchers, cook pots, pans, water bottles, cauldrons, mugs, crockpots, etc. In one embodiment, at least one handle 112 extends from the body 110 to act as a point of contact for a user. The handle 112 may be made of the same material as the body 110, or the handle 112 may be made of a heat resistant material, such as a plastic, rubber, or silicone, that allows a user to grab the device 100 when the contents and/or the body 110 of the device 100 are hot.

In the preferred embodiment, the device 100 is comprised of three segments (but at least two) 120,130,140 that can be easily assembled or disassembled. The first segment 120 of the device 100 is comprised of an at least one O-ring 122, a bottom edge 124, and at least one fastener 126. The first segment 120 may connect to the second segment 130, which is further comprised of an interior surface 132, at least one fastener 134, a top edge 136, and a bottom edge 138. Further, the second segment 130 may connect to the third segment 140, which is further comprised of an at least one O-ring 142, a top edge 144, and at least one fastener 146.

During use, the fastener 134 of the second segment 130 attaches to the fastener 126 of the first segment 120, and to the fastener 146 of the third segment 140, as best seen in FIG. 1. In the preferred embodiment of the device 100, the fasteners 126,146 of the first segment 120 and the third segment 140 are male threads that can be screwed into the female threads of the fastener 134 of the second segment 130. The fastener 134 of the second segment 130 is preferably attached to the interior surface 132 of the second segment 130. Further, the fasteners 126,146 of the first 120 and third 140 segments may extend from each segment 120,140 to connect to the fastener 134 of the second segment 130. In differing embodiments, however, the fasteners 126,134,146 may be any fastener known in the art such as, but not limited to, tongue and groove fasteners, snap-fit fasteners, set screws, bolts, nails, tape, adhesives, magnets, etc.

When the male threads of the fasteners 126,146 of the first segment 120 and third segment 140 are fully secured to the female threads of the fastener 134 of the second segment 130, the body 110 becomes sealed and watertight. To accomplish this, the bottom edge 124 of the first segment 120 is firmly pressed into the top edge 136 of the second segment 130. The bottom edge 124 of the first segment 120 may be lined with a high-temperature watertight O-ring 122 to fully seal the connection between the first 120 and second 130 segments. Likewise, the top edge 144 of the third segment 140 is firmly pressed into the bottom edge 136 of the second segment 130. The top edge 144 of the third segment 140 may be lined with a high-temperature watertight O-ring 142 to fully seal the connection between the third 140 and second 130 segments.

The device 100 may also be comprised of a lid 150 which is comprised of an at least one handle 152. The lid 150 may be made of the same material as the body 110 of the device 100, or may be made of a differing material, such as glass, which allows a user to see the contents inside. The handle 152 of the lid 150 may be made of a heat-resistant material, such as a plastic, rubber, or silicone, to allow a user to remove the lid 150 even if the lid 150 is hot to touch.

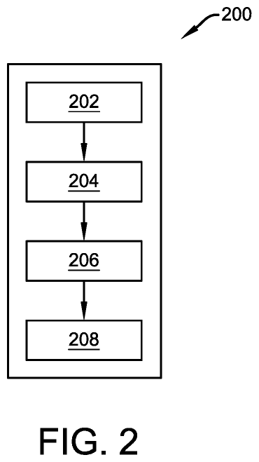

The present invention is also comprised of a method 200 of using the device 100, as seen in FIG. 2. First, a device 100 is provided comprised of a body 110 with at least a first segment 120 and a second segment 130 [Step 202]. Then, the device 100 may be assembled by attaching a fastener 126 of the first segment 120 to a fastener 134 of the second segment 130 [Step 204]. Then, the device 100 may be disassembled by the second segment 130 from the first segment 120 [Step 206]. Then, each segment 120,130 of the device 100 may be cleaned either by hand or by being placed in the dishwasher [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “multi-piece cookware device” and “device” are interchangeable and refer to the multi-piece cookware device 100 of the present invention.

Notwithstanding the foregoing, the multi-piece cookware device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the multi-piece cookware device 100 as shown in the FIGS. are for illustrative purposes only, and that many other sizes and shapes of the multi-piece cookware device 100 are well within the scope of the present disclosure. Although the dimensions of the multi-piece cookware device 100 are important design parameters for user convenience, the multi-piece cookware device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-piece cookware device comprising:
a body comprised of:
a first segment comprised of a first fastener; and
a second segment comprised of a second fastener; and
an O-ring.

2. The multi-piece cookware device of claim 1, wherein the first fastener is comprised of a male thread.

3. The multi-piece cookware device of claim 1, wherein the second fastener is comprised of a female thread.

4. The multi-piece cookware device of claim 1, wherein the O-ring is positioned between the first segment and the second segment.

5. The multi-piece cookware device of claim 1, wherein the body is comprised of piece of cookware.

6. The multi-piece cookware device of claim 5, wherein the piece of cookware is comprised of a drink pitcher, a cook pot, a pan, a water bottle, a cauldron, a mug, or a crockpot.

7. The multi-piece cookware device of claim 1, wherein the first segment is comprised of a stainless steel, an aluminum, a ceramic, a cast iron, a plastic, a copper, or a glass material.

8. The multi-piece cookware device of claim 1, wherein the second segment is comprised of a stainless steel, an aluminum, a ceramic, a cast iron, a plastic, a copper, or a glass material.

9. The multi-piece cookware device of claim 1, wherein the body is comprised of a handle.

10. A multi-piece cookware device comprising:
a body comprised of:
a first segment comprised of a first fastener and a flat bottom edge; and
a second segment comprised of a second fastener and a flat top edge; and
an O-ring.

11. The multi-piece cookware device of claim 10, wherein the body is comprised of piece of cookware.

12. The multi-piece cookware device of claim 11, wherein the piece of cookware is comprised of a drink pitcher, a cook pot, a pan, a water bottle, a cauldron, a mug, or a crockpot.

13. The multi-piece cookware device of claim 10, wherein the first segment is comprised of a stainless steel, an aluminum, a ceramic, a cast iron, a plastic, a copper, or a glass material.

14. The multi-piece cookware device of claim 10, wherein the second segment is comprised of a stainless steel, an aluminum, a ceramic, a cast iron, a plastic, a copper, or a glass material.

15. The multi-piece cookware device of claim 10, wherein the O-ring is positioned between the flat bottom edge and the flat top edge.

16. The multi-piece cookware device of claim 10, wherein the body is comprised of a first handle.

17. The multi-piece cookware device of claim 10 further comprised of a lid.

18. The multi-piece cookware device of claim 17, wherein the lid is comprised of a second handle.

19. The multi-piece cookware device of claim 18, wherein the second handle is comprised of a heat-resistant material.

20. A method of using a multi-piece cookware device, the method comprising the steps of:
providing a multi-piece cookware device comprised of a body with a first segment and a second segment;
attaching a first fastener of the first segment to a second fastener of the second segment;
disassembling the second segment from the first segment; and
washing the first segment and the second segment.
